(19) United States
(12) Patent Application Publication
(10) Pub. No.: US 2009/0266807 A1
(43) Pub. Date: Oct. 29, 2009

(54) OVEN CONTROL SYSTEM

(75) Inventor: Venkatachalam VALLIAPPAN, Singapore (SG)

Correspondence Address: SUGHRUE MION, PLLC, 2100 PENNSYLVANIA AVENUE, N.W., SUITE 800, WASHINGTON, DC, 20037, US

(73) Assignee: United Test and Assembly Test Center Ltd., Singapore (SG)

(21) Appl. No.: 12/430,383

(22) Filed: Apr. 27, 2009

Related U.S. Application Data
(60) Provisional application No. 61/048,600, filed on Apr. 29, 2008.
(60) Provisional application No. 61/107,147, filed on Oct. 21, 2008.

(51) Int. Cl. F27D 11/00

(52) U.S. Cl. 219/391

(57) ABSTRACT

An oven control system and methods of operating the same are disclosed. The oven control system provides various automated tracking and control functions to reduce errors and defects in oven cure operations.

### CROSS-REFERENCE TO RELATED APPLICATIONS

This application claims priority from U.S. Provisional Application Nos. 61/048,600 filed on Apr. 29, 2008, and 61/107,147 filed on Oct. 21, 2008, the disclosure of which are incorporated herein by reference.

### BACKGROUND OF INVENTION

1. Field of Invention

Embodiments of the invention relate to an OCS (Oven Control System) and methods of operation, and more particularly to an automated oven control system deployed for test/post-test operations, and in assembly oven cure operations.

2. Description of the Related Art

Oven cure operations are one of the steps that occur during assembly of semiconductor packages. Such operations involve curing of sub-assembled chips and may be deployed at various stages of the assembly process. Applications of oven cure operations include, but are not limited to, B-stage process, Lead on Chip cure process, Die Attach cure process, Mold Cure process, Ink Mark Cure, Pre-bake/Re-bake process, underfill cure, flip chip cure and heat sink attach cure.

Current practices for monitoring oven cure operations are carried out manually, and are prone to the various problems, including but not limited to, failure to load a correct lot into an oven which has been configured with a certain curing recipe; human errors due to manual recording of oven cure transactions and process parameters; and failure to identify defective lots.

### SUMMARY OF THE INVENTION

Exemplary embodiments of the invention overcome the above disadvantages and other disadvantages not described above. Also, the present invention is not required to overcome the disadvantages described above, and an exemplary embodiment of the present invention may not overcome any of the problems described above.

An oven control system (OCS) has been designed to, amongst others, reduce or eliminate process-related quality problems due to non-curing or inappropriate curing, such as by providing various automated functions to reduce errors and defects in oven cure operations. According to one embodiment of the invention, an oven curing system may comprise an oven having an oven chamber, one or more temperature sensors disposed in the oven chamber, a computing device to perform various automated tracking and control functions. Examples of such functions include, but are not limited to, tracking and displaying an actual temperature profile of the oven during a cure operation, ascertaining a presence of defects or errors such as by ascertaining whether a deviation of the actual temperature profile from a predetermined temperature profile associated with a designated oven recipe breaches a predetermined threshold, detecting lot identification of each lot of semiconductor work piece and tracking the status of the lots, controlling access to an oven chamber based on an operation status of the oven.

Methods for processing a semiconductor work piece using an oven control system are also disclosed in certain other embodiments of the invention.

### BRIEF DESCRIPTION OF THE DRAWINGS

The above and/or other aspects of the invention will become apparent and more readily appreciated from the following description of the exemplary embodiments, taken in conjunction with the accompanying drawings, in which:

FIG. 1 illustrates an OCS according to one embodiment of the invention;

FIG. 2 is a flow sequence for an oven cure operation according to one embodiment of the invention;

FIGS. 3A to 3H illustrate examples of a user interface for the OCS;

FIG. 4 is a perspective view of an exemplary curing oven;

FIG. 5 illustrates an exemplary OCS architecture;

FIG. 6 shows an exemplary OCS functional block diagram.

### DETAILED DESCRIPTION OF EXEMPLARY EMBODIMENTS OF THE INVENTION

Hereinafter, exemplary embodiments of the invention will be described with reference to the accompanying drawings. In the following description, numerous specific details are set forth in order to provide a thorough understanding of various illustrative embodiments of the invention. It will be understood, however, to one skilled in the art, that embodiments of the invention may be practiced without some or all of these specific details. In other instances, well known process operations have not been described in detail in order not to unnecessarily obscure pertinent aspects of embodiments being described. In the drawings, like reference numerals refer to same or similar functionalities or features throughout the several views.

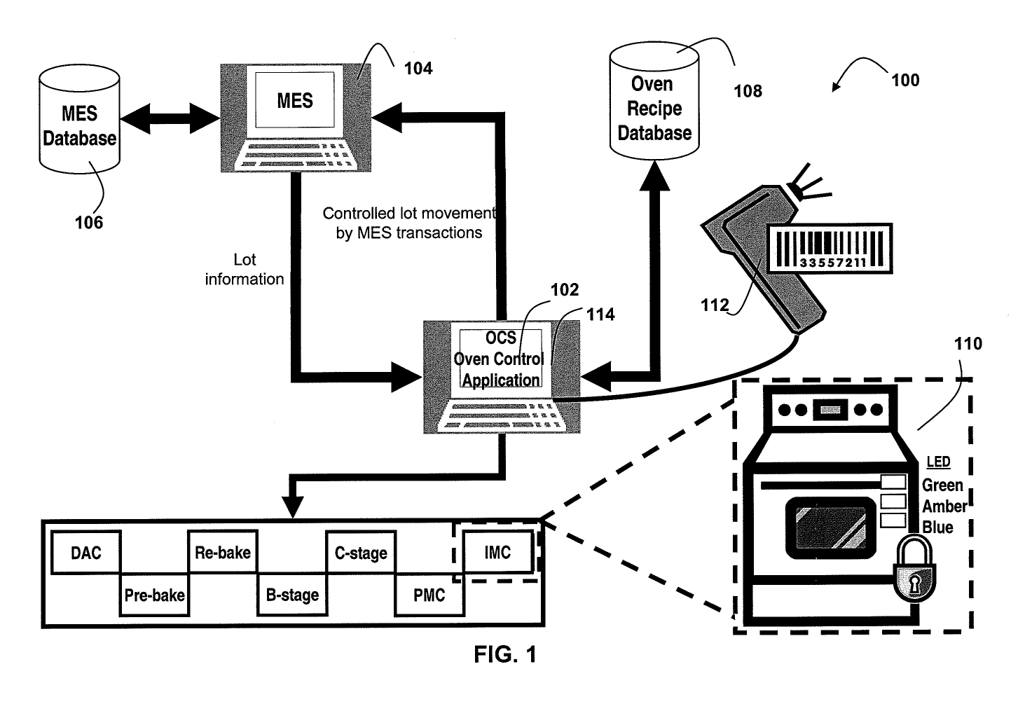

Embodiments of the invention disclose an Oven Control System (OCS) 100. Reference is now made to FIG. 1 in which an OCS application 102, embodied in a computing device 114, may be integrated with a manufacturing execution system (MES) 104, e.g., PROMIS MES. The MES 104 may be coupled to a MES Database 106 which stores lot information such as product code and oven recipe for each lot of semiconductor work pieces to be processed. The OCS application 102 may also be coupled to the MES 104 to monitor and control lot movement and lot information. More particularly, the OCS application 102 may notify the MES 104 as and when a lot is brought to an oven 110 for a cure operation, and may also retrieve lot information from a MES database 106 via the MES 104. The OCS application 102 may also be coupled to an oven recipe database 108 from which is extracted a designated oven recipe to configure an oven 110 for a particular oven cure operation. Recipes in the oven recipe database 108 include, but are not limited to, Die Attach Cure (DAC), Re-Bake, Pre-Bake, B-Stage cure, Lead on Chip (LOC) cure, Mold cure, Post Mold Cure (PMC), Ink Marking Cure (IMC), Pre-bake/Re-bake process, underfill cure, flip chip cure and heat sink attach cure. For each oven recipe, the oven recipe database 108 may further store a predetermined or desired temperature profile and other information which may assist in ascertaining whether or not a defect or an error has occurred during a cure operation. In each cure operation, the OCS application 102 retrieves from the oven recipe database 108 and downloads a required oven recipe into a selected oven 110 at an appropriate time.

The OCS application 102 may be coupled to a detection device 112 for ascertaining lot identifier(s) and transmitting the ascertained lot identifier(s) to the OCS application 102. An appropriate tracking medium, e.g., barcode, or Radio Frequency (RF) labels which contain lot identification may be tagged to each lot. Accordingly, examples of a suitable detection device 112 include, but are not limited to, a barcode scanner and a radio frequency (RF) label scanner.

A display device may further be coupled to the OCS application 102 to allow an operator view both actual and predetermined temperature profiles while a cure operation is in progress. The display device may also allow an operator view notifications which may arise during a curing operation.

The MES database 106 or a separate database provided in the OCS 100 may further store process information of each cure operation which has been performed. Examples of process information include, but are not limited to, actual temperature readings, oven equipment identifier, oven recipe name, date and time of curing process, operator identifier. Reports and data log, such as temperature profile charts and records for each lot processed, oven equipment identification, oven recipe names, date and time stamps, may be retrieved from the MES database 106 and accessed from a local computing device 114 or a remote computing device connected to the factory local area network (LAN). Reports may also be accessed through web-based interfaces and downloaded into spreadsheets, such as Excel.

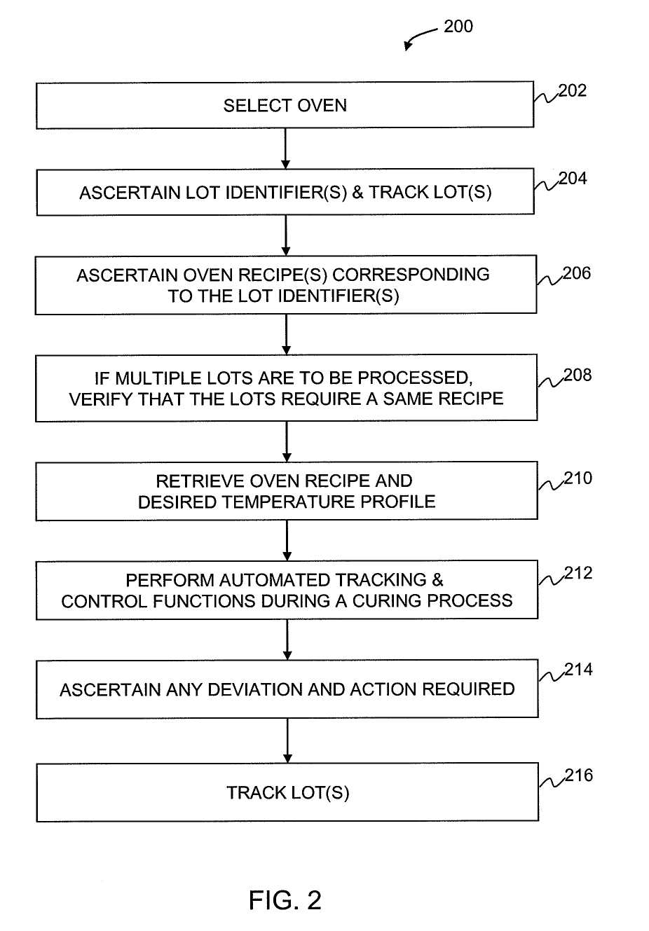

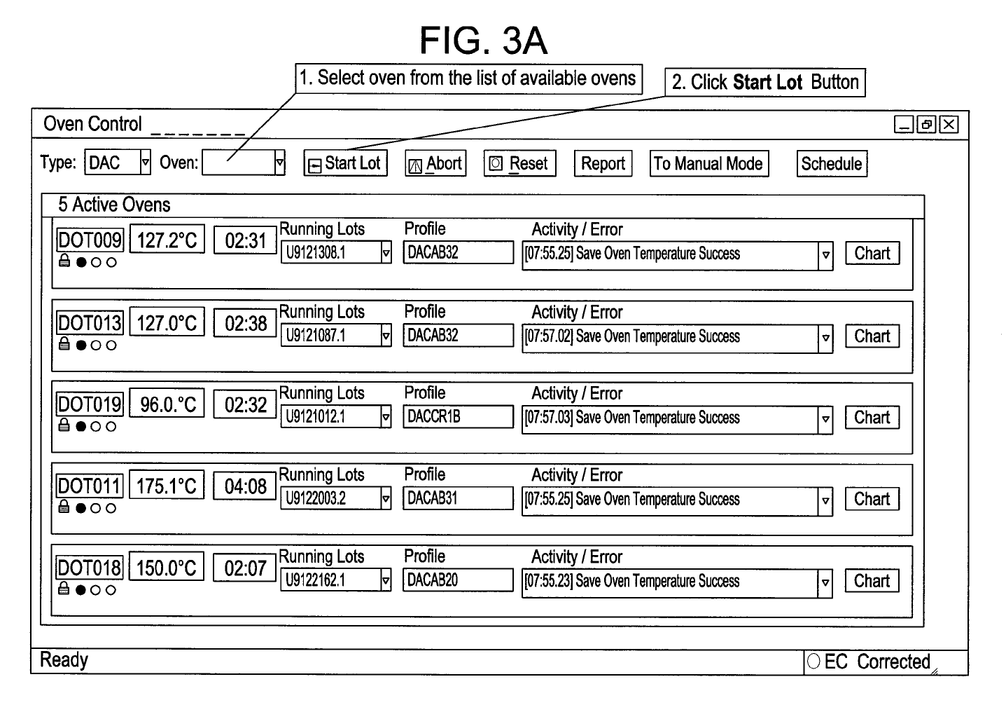

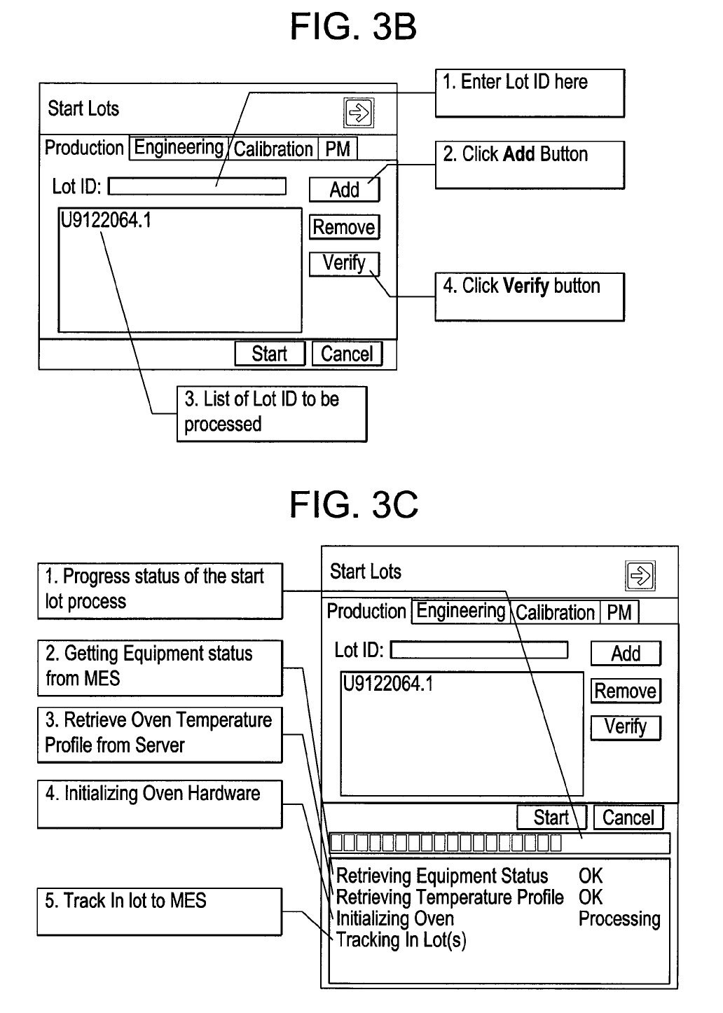

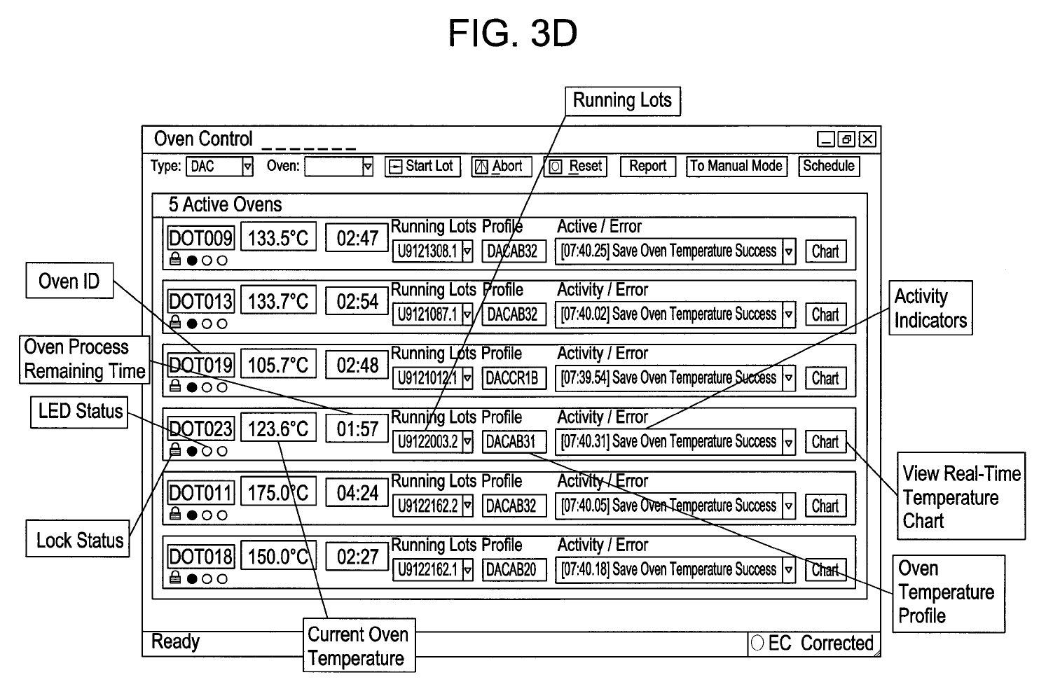

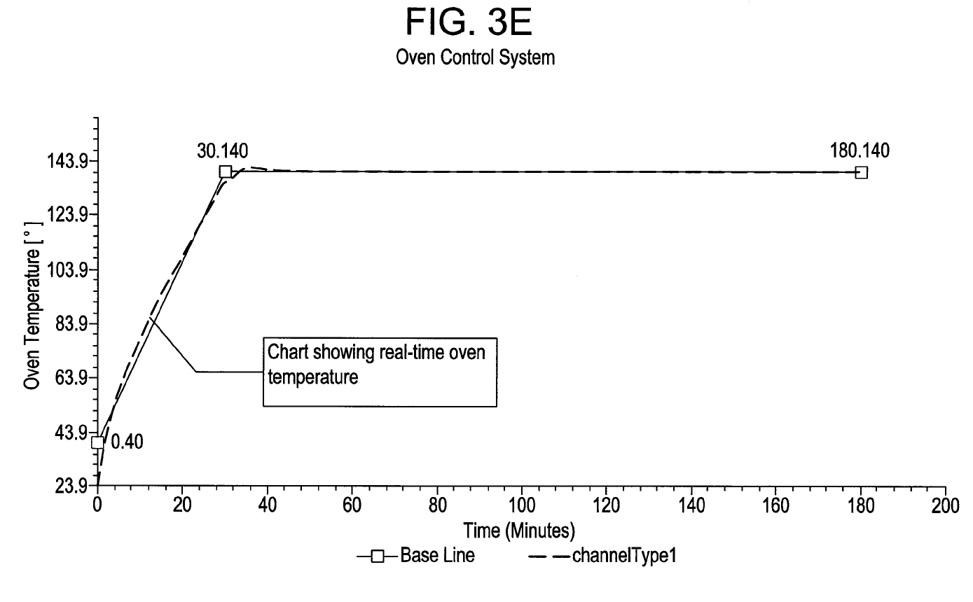

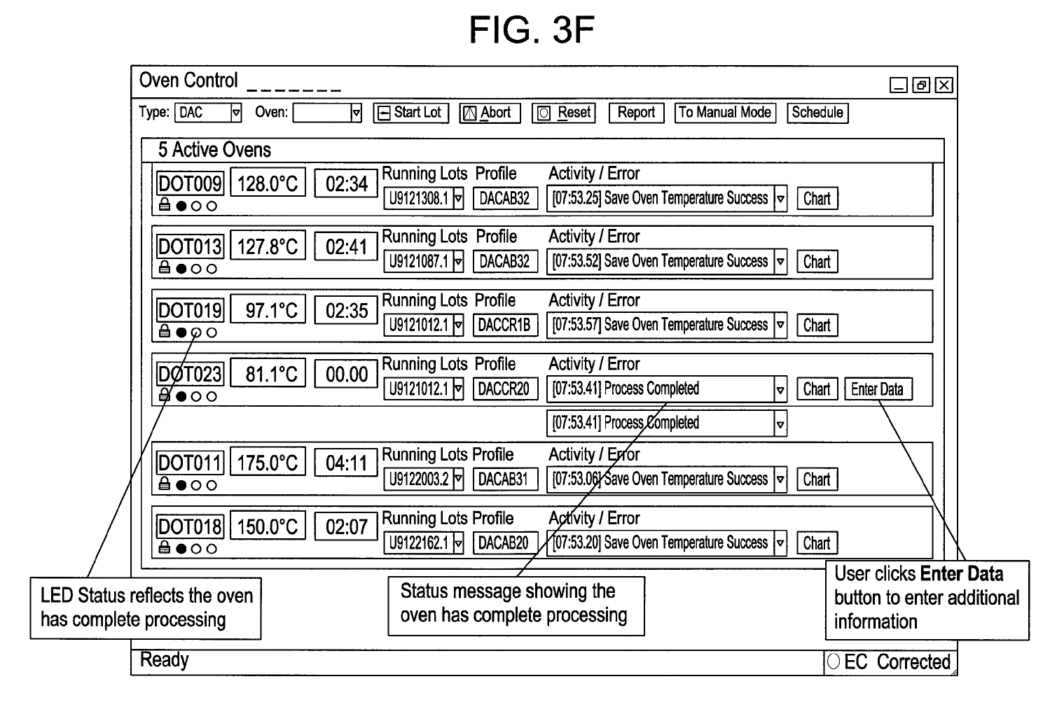

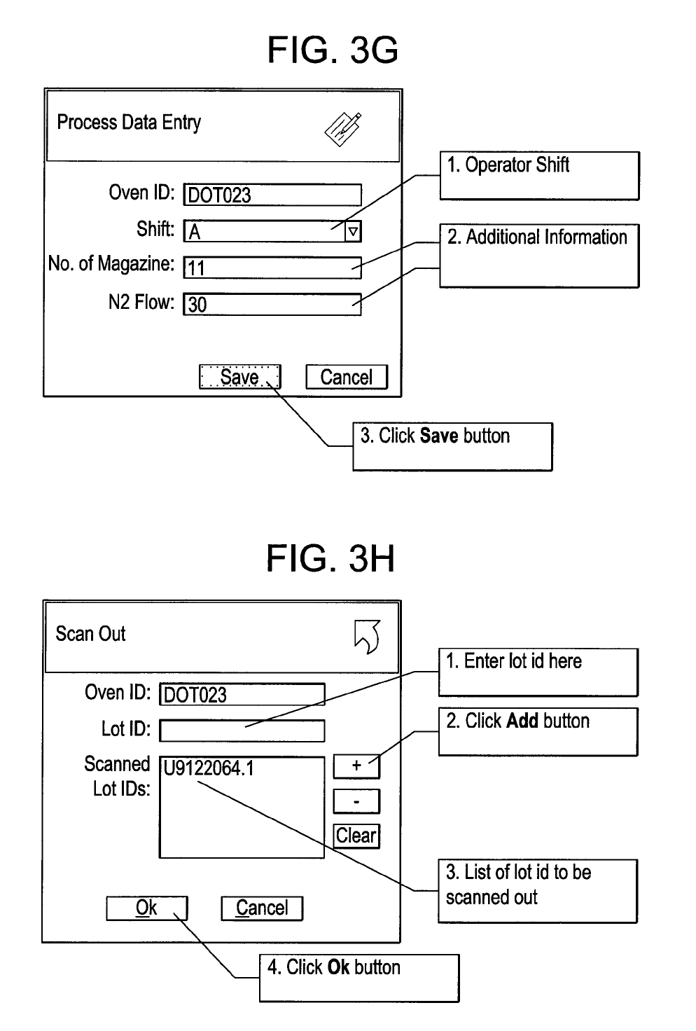

FIG. 2 is a flow sequence 200 for an oven cure process according to one embodiment of the invention. The flow sequence 200 will be described with further reference to FIGS. 3A to 3H which show examples of a user interface of the OCS application 102.

The flow sequence 200 of FIG. 2 begins when one or more lots of semiconductor work pieces are required to undergo an oven curing process. An operator handling the lot(s) may first select an appropriate oven 110 from a list of available ovens (block 202) using an OCS user interface such as that shown in FIG. 3A, and issue a start command. If required, the operator may be prompted to input an operator identifier and/or password to proceed with the flow sequence 200.

The lot(s) to be processed may be tracked in the MES 104 by first ascertaining the lot identifier(s) (block 204). To this purpose, the operator may be prompted (see FIG. 3B) to enter one or more lot identifiers by manual entry, or automatic detection, or both. Automatic detection may be achieved by providing an appropriate tracking medium, e.g. barcode, Radio Frequency (RF) labels, on the lots and further providing an appropriate detection device 112, e.g. barcode scanner, RF label scanner, to ascertain the lot identifier(s) which are then provided to the OCS application 102. Based on the ascertained lot identifier(s), the OCS application 102 retrieves corresponding lot information, e.g. product code and designated oven recipe identifier, from a MES database 106 (block 206). The designated oven recipe identifier refers to an oven recipe which is required to subsequently process a particular lot according to a designated manufacturing process.

In certain embodiments, multiple lots may be cured simultaneously in an oven 110 provided that the lots share a common designated oven recipe. The OCS application 102 may verify this before further proceeding with the flow sequence 200. More particularly, based on the lot identifiers ascertained for the multiple lots, designated oven recipe or identifiers thereof are retrieved and verified as to whether the lots require a same designated recipe (block 208). This verification would ensure that a correct oven recipe is applied if multiple lots are desired to be cured in a single operation. If the designated oven recipe identifiers are verified as the same, the flow sequence 200 may proceed. If the designated oven recipe identifiers are verified as different, an error notification may be generated and provided to an operator. The flow sequence 200 may then await the operator's intervention before proceeding.

The operator may be prompted to physically load the lot(s) to be processed into the selected oven and to initiate the curing operation. The designated oven recipe and a predetermined or desired temperature profile corresponding to the designated oven recipe may be retrieved from the oven recipe database 108 into the selected oven 110 to configure the oven 110 for a cure operation (block 210 and FIG. 3C). The OCS application 102 may further perform initialization of the oven 110 and/or other checks, e.g. verify the lot(s) are placed in the oven 110, verify the access door of the oven is closed, track in the lot(s) in the MES 104. Once the download and initialization are completed, the OCS application 102 executes the designated oven recipe in the selected oven 110 to process the lot(s).

During execution of the oven recipe, the OCS application 102 may perform several automated tracking and control functions (block 212). Parameters that are being tracked or controlled may be displayed using one or more user interfaces (see FIGS. 3D to 3F). The OCS application 102 may track the actual temperature of the oven 110 in real-time or at predetermined intervals, e.g. 1 minute, and present the actual temperature profile obtained therefrom as a chart on a display device. The chart may be updated as and when temperature readings are obtained (see FIG. 3E). The chart may also juxtapose the predetermined or desired temperature profile with the actual temperature profile to provide a visual comparison.

Further, the OCS application 102 may control access to the oven 110 according to a cure operation status. For example, if a curing operation is in progress, the OCS application 102 may restrict access to the oven 110, such as, by activating a lock system 406 of the oven 110. This would prevent accidental opening of the oven access door 404 which may result in defective curing. If the curing operation is completed or if it is required to ramp down oven temperature, the OCS application 102 may inactivate the lock system 406 and cause the access door 404 to open. Status of the lock system 406 may be shown in the user interface (see FIG. 3D).

Yet further, status of the curing process may be reflected on the oven 110, such as by providing LED lights 408 or other suitable indicators. Various operation status may be reflected, for example, a Blue LED indicates “pending curing”, a Green LED indicates “completed”, and an Amber LED indicates “standby”. The curing process status may also be shown in the user interface (see FIG. 3D). Other parameters may also be tracked and shown in the user interface. Examples of other parameters include, but are not limited to, oven identifier, current oven temperature, remaining time to complete a current process, identification of lot(s) being processed, identification of the oven cure recipe in progress, and activity/error indicators. As illustrated in FIG. 3, the OCS application 102 may simultaneously control and track cure operations in several ovens 110.

Upon completion of a curing operation, an operator may be appropriately notified, such as through the user interface. In FIG. 3F, the user interface may indicate a status of the curing operation and provide an option to enter additional information. FIG. 3G illustrates a user interface for entering additional information, e.g. operator shift, number of magazines, nitrogen flow, paste thickness. The additional information may be stored in a MES database 106, server or other appropriate medium for report generation. The OCS application 102 may also allow download of oven recipes, and the upload of actual curing temperature profiles and related data after completion of a curing process.

Also upon completion of the curing operation, or at other appropriate times as required, the OCS application 102 may ascertain a deviation between an actual temperature profile of the oven and a predetermined temperature profile for a particular oven recipe (block 214). If the deviation breaches a certain predetermined threshold for that particular oven recipe, the OCS application 102 may notify an operator so that the lot(s) may be assessed. If the deviation is within a predetermined acceptable range, the OCS application 102 may render the curing operation complete and notify an operator accordingly. Further, if defects, e.g. under-curing and over-curing, or errors, e.g. actual curing profile deviates substantially from the predetermined curing profile, have occurred during the oven curing process, this information would be reported to MES 104 which may hold the lot(s) for assessment to determine the next course of action, e.g., if a re-cure is needed or if the lot(s) should be scrapped. This way, the OCS 100 may achieve automatic detection of errors.

The lot(s) that have been processed may be scanned out of the OCS 100. To this purpose, the operator may be prompted to enter an operator identifier and/or password, and also to enter or detect the lot identifier(s) to be scanned out. After the correct lot identifier(s) are entered, the lots(s) would then be tracked out in the MES 104 for traceability purposes, and the status for the lot(s) updated in a MES server 104 or other appropriate server/database (block 216).

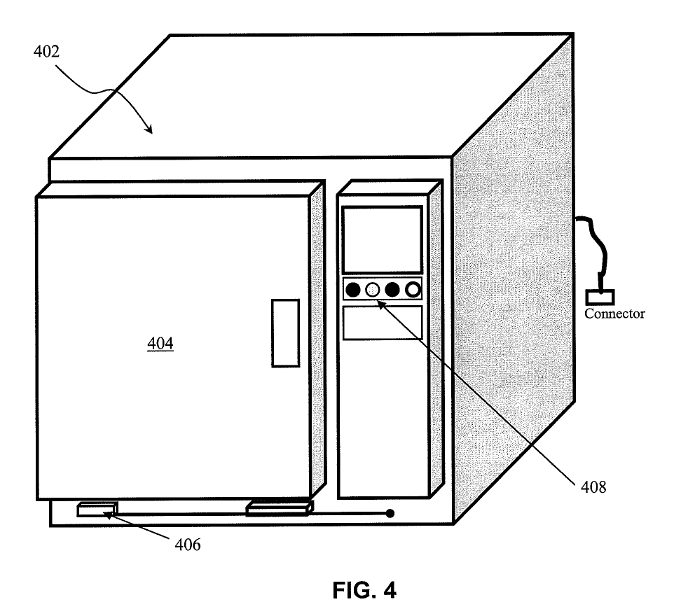

FIG. 4 is a perspective view of an exemplary curing oven 110. The oven 110 may include an oven chamber 402, an access door 404 leading to the oven chamber 402, a lock system 406 and at least one status indicator 408 provided on a front panel of the oven 110. The oven chamber 402 is suitably dimensioned so that one or more lots of semiconductor work pieces may be disposed therein for curing. Various methods are available to provide heating function in the oven chamber 402. For example, one or more heaters may be suitably disposed in the oven chamber 402. In another example, a heated gas may be injected into the oven chamber 402 and subsequently withdrawn from the oven chamber 402. It should be appreciated that other methods known to persons skilled in the art may be applicable.

The access door 404 of the oven 110 may be controlled by a lock system 406 which may include an electromagnet lock, a door magnet sensor and, a relay to trigger locking and unlocking of the door. The lock system 406 may be controlled by the OCS application 102 according to a progress status of a curing operation. For example, when a curing process is commencing or in progress, the electromagnet lock is activated to keep the access door 404 locked, thereby providing a sealed enclosure to the oven chamber 402. In this manner, the lock system 406 ensures that manual opening of the access door 404 is prohibited, thereby eliminating a likelihood of accidental door opening which possibly leads to inappropriate curing or non-curing. However, in case of an emergency, the access door 404 can be released by pressing an emergency button. This would allow the lot(s) to be salvaged in case there is a physical breakdown of the oven 110. In another example, upon completion of a curing process, the lock system 406 may be automatically inactivated to allow manual opening of the access door 404 by an operator. In yet another example, upon completion of a curing operation, the lock system 406 may be automatically inactivated and the access door 404 caused to open to achieve certain rate of temperature decrease as required by certain curing processes. This way, the OCS 100 as illustrated in FIG. 1 may achieve automated remote control of the access door 406 to allow or restrict access to the oven chamber 402, and to provide a sealing enclosure to the oven chamber 402 during a curing operation.

One or more status indicators may be provided on a front panel of the oven 110 to inform an operator of a current cure status. Examples of a status indicator include, but are not limited to, a plurality of LED lamps representing various cure status, and a display screen showing a cure status.

One or more temperature sensors, e.g. thermocouplers or other suitable devices may be provided in the oven chamber 402 to ascertain a temperature reading of the oven chamber 402 real-time or at a predetermined frequency, e.g. every one minute. Each temperature reading may be stored in a database, e.g. MES database 106, and used to provide an actual temperature profile detailing actual temperature readings over a period of time or throughout a curing operation.

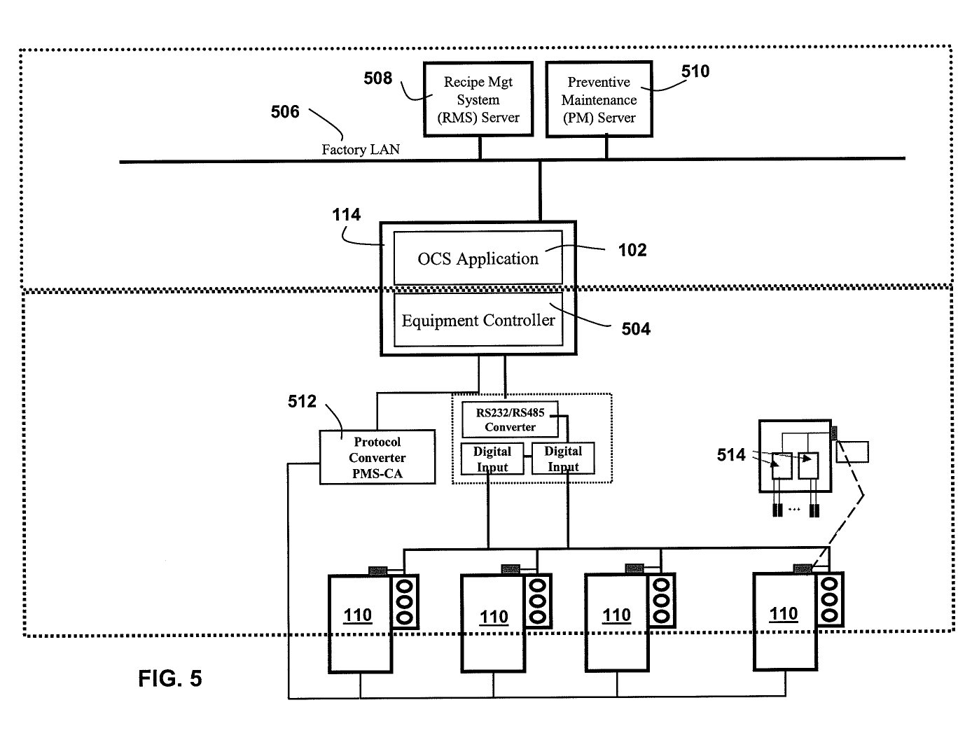

FIG. 5 illustrates an OCS system architecture in which a computing device 114 or microprocessor may contain an OCS application program 102 for executing the oven control system, and coupled to an equipment controller 504. The computing device 114 may be coupled to one or more ovens 110 through the equipment controller 504, and to other components including, but not limited to, a detection device 112, a display device, an oven recipe database 108, the MES 104 and a MES database 106. FIG. 5 also shows an integration between an OCS application 102 to a factory LAN 506 (local area network) with information managed via two servers, i.e., a recipe management server 508 and a preventive maintenance server 510. FIG. 5 further shows an integration between the equipment controller 504 and a plurality of ovens 110 via a protocol converter (PMS-CA) 512. A protocol converter may be required to allow communication between the computing device 114 and the ovens 110 in certain embodiments where the computing device 114 and the ovens 110 are coupled across different networks, e.g. the computing device 114 uses RS232 (COM port) connections while the ovens use RS485 connections. The ovens 110 may be coupled to thermocouple input modules 514, containing temperature sensors, which are to ascertain temperature readings during oven cure operations and transmit the temperature readings to the OCS application 102 in the computing device 114. While FIG. 5 illustrates a computing device 114 being electrically coupled to four ovens 110, it is to be appreciated that the computing device 114 may be coupled to a single oven or to multiple ovens in certain other embodiments of the invention. Further, it is to be appreciated that the equipment controller 504 may be provided separate from the computing device 114, or the equipment controller 504 and/or computing device 114 may be integrated with the oven 110 where required.

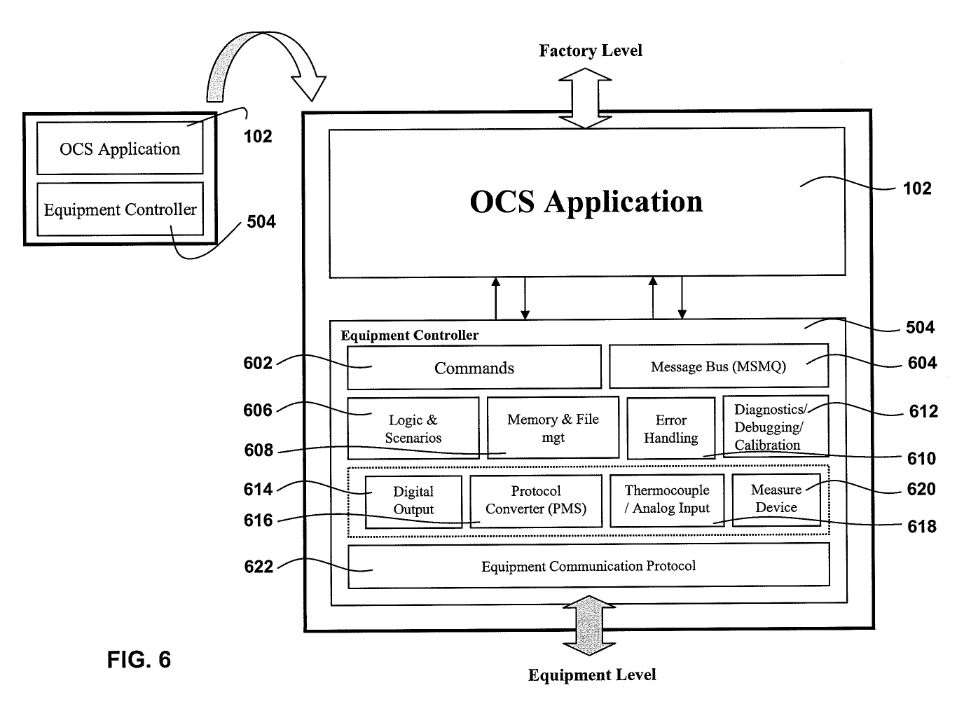

FIG. 6 shows an exemplary OCS functional block diagram, which describes an integration between the detailed feature blocks of the equipment controller software and the OCS application 102. For example, the equipment controller can include the following functional blocks: a commands module 602 to control various oven commands e.g. to control oven sequence of operations such as power on, power off, door relay on/off, light indicators on/off, profiles on/off, a message bus module (MSMQ) 604 to transfer communication messages between OCS application and equipment controller, a logic and scenarios module 606 to contain control operations logic such as door relay on /off, profiles, indicator lights on/off, different operation stages scenario, a memory and file management module 608 to record oven operations event log files and current lot transactions, an error handling module 610 to handle systems errors, e.g. protocol converter errors, out of temperature errors, system alarms/buzzer, a diagnostics/debugging/calibration module 612 to simulate oven physical operations e.g. cooler/buzzer/door relays, magnetic locks and various hardware check working status, a digital output module 614 to control on/off of the light indicators, a protocol converter (PMS) module 616 for oven commands transfer to protocol converter hardware to control the oven, a thermocouple/analog input module 618 to process freezer analog input to record the freezer temperature in systems where a freezer is required, measure device 620 for temperature recording during preventive maintenance and equipment communication protocol 622 for communication between PC/protocol converter and oven controller.

Other embodiments will be apparent to those skilled in the art from consideration of the specification and practice of the present invention. Furthermore, certain terminology has been used for the purposes of descriptive clarity, and not to limit the invention. The embodiments and features described above should be considered exemplary. It will be understood by those of ordinary skill in the art that various changes in form and details may be made therein without departing from the spirit and scope of the invention as defined by the following claims.

What is claimed is:

1. An oven curing system comprising:
an oven having an oven chamber;
at least a temperature sensor disposed in the oven chamber; and
a computing device coupled to the temperature sensor to receive a plurality of temperature readings therefrom to ascertain an actual temperature profile of the oven during processing of at least a first lot of semiconductor work piece using a first oven recipe, and to ascertain a deviation of the actual temperature profile from a predetermined temperature profile associated with the first oven recipe.

2. The oven curing system of claim 1, wherein the computing device is to ascertain a breach of a predetermined threshold associated with the first oven recipe by the deviation of the actual temperature profile from the predetermined temperature profile.

3. The oven curing system of claim 2, wherein the computing device is to notify an operator of the breach of the predetermined threshold.

4. The oven curing system of claim 1, further comprising a display device coupled to the computing device to display the actual temperature profile during processing.

5. The oven curing system of claim 4, wherein the display device is to display the actual temperature profile in juxtaposition with the predetermined temperature profile.

6. The oven curing system of claim 1, further comprising:
a lock system coupled to the computing device to control an access to the oven chamber based on an operation status of the oven.

7. The oven curing system of claim 1, further comprising a detection system coupled to the computing device to ascertain a lot identifier of the first lot of semiconductor work piece.

8. The oven curing system of claim 1, further comprising a database coupled to the computing device to store the first oven recipe, and a predetermined temperature profile and a predetermined threshold associated with the first oven recipe.

9. The oven curing system of claim 1, further comprising a plurality of indicators coupled to the computing device to indicate an operation status of the oven.

10. The oven curing system of claim 1, wherein the computing device is to ascertain the plurality of temperature readings at a predetermined time interval.

11. A method for processing a semiconductor work piece, the method comprising:
ascertaining a first oven recipe required by a first lot of semiconductor work piece;
retrieving a predetermined temperature profile corresponding to the first oven recipe;
while processing the first lot with the first oven recipe, ascertaining an actual temperature profile of the oven; and
ascertaining a deviation of the actual temperature profile from the predetermined temperature profile.

12. The method of claim 11, further comprising: ascertaining the deviation of the actual temperature profile from the predetermined temperature profile is a breach of a predetermined threshold.

13. The method of claim 12, further comprising: notifying an operator of the breach of the predetermined threshold.

14. The method of claim 11, further comprising: displaying the actual temperature profile and updating a display of the actual temperature profile at predetermined intervals.

15. The method of claim 11, further comprising: controlling an access to the oven based on an operation status of the oven.

16. The method of claim 11, further comprising: ascertaining that the first oven recipe is required by a second lot, and processing the second lot simultaneously with the first lot.

17. The method of claim 11, further comprising: ascertaining a first lot identifier of the first lot by detecting a tracking medium associated with the first lot.

18. The method of claim 11, wherein ascertaining an actual temperature profile of the oven includes ascertaining a plurality of temperature readings at a predetermined time interval.
